(19) United States
(12) Patent Application Publication
(10) Pub. No.: US 2013/0015925 A1
(43) Pub. Date: Jan. 17, 2013

(54) DELAY LINE STRUCTURE

(71) Applicants: GUANG-HWA SHIUE, CHUNG LI (TW); JIA-HUNG SHIU, CHUNG LI (TW)

(72) Inventors: GUANG-HWA SHIUE, CHUNG LI (TW); JIA-HUNG SHIU, CHUNG LI (TW)

(73) Assignee: CHUNG YUAN CHRISTIAN UNIVERSITY, CHUNG LI (TW)

(21) Appl. No.: 13/224,516

(22) Filed: Sep. 2, 2011

(30) Foreign Application Priority Data
Jul. 14, 2011 (TW) 100124953

(51) Int. Cl. H01P 1/18

(52) U.S. Cl. 333/161

(57) ABSTRACT

A delay line structure has a serpentine delay line pair, a first and second grounding guard trace and two third grounding guard traces. The delay line pair is located in a layout layer extending from an input to an output end, The first and second grounding guard traces are connected to the grounding circuit through respective vias and are located in the layout layer. The third grounding guard traces are respectively located in the layout layer by an upper and lower edge of the delay line pair and are connected to the grounding circuit through respective vias.

This application claims the benefits of the Taiwan Patent Application Serial No. 100124953 filed on Jul. 14, 2011, the subject matter of which is incorporated herein by reference.

### BACKGROUND OF THE INVENTION

1. Field of the Invention

The present invention relates to a delay line structure, and more particularly to a differential serpentine delay line structure with grounding guard traces and strong coupling line segments.

2. Description of the Prior Art

Signal synchronizing is always a concern when it comes to the high speed digital signal. Usually the requirement of synchronizing signals is met by increasing the delay time with a delay line.

To save space, the delay line is usually bent. There are various delay lines, among which a differential serpentine delay line is very common. Referring to FIG. 1, FIG. 1 illustrates a delay line structure in the prior art. A differential serpentine delay line pair 11 is bent repeatedly, arranged on a substrate 100, and includes two serpentine delay lines 111 and 112.

However, bending the serpentine delay lines generates unequal lengths of signal lines and generates crosstalk noise disturbance in horizontal line segments, and further affects a signal waveform received, which leads to misinterpretation on a voltage level of a digital signal. Although grounding guard traces are applied to reduce the crosstalk noise disturbance, the result is still not ideal.

### SUMMARY OF THE INVENTION

A differential serpentine delay line structure with grounding guard traces and strong coupling line segments is provided according to the present invention. The delay line structure effectively reduces common-mode noises generated by the unequal length of differential delay lines and crosstalk effects.

A delay line structure is disposed on a substrate. The substrate includes a grounding layer and a layout layer, wherein the grounding layer includes a grounding circuit. The delay line structure accordingly includes a serpentine delay line pair including two parallel serpentine delay lines, at least a first grounding guard trace, at least a second grounding guard trace, and two third grounding guard traces.

The serpentine delay line pair is disposed in the layout layer in a manner of extending from an input end to an out put end in serpentine so as to form at least a first coupling area having a first opening toward a first direction and at least a second coupling area having a second opening toward a second direction opposite to the first direction, wherein the widths of the parallel serpentine delay lines are smaller when the serpentine delay lines are bent.

The first grounding guard trace is disposed in the layout layer in a manner of extending from the first opening toward the first coupling area, having an interval between the first grounding guard trace and the serpentine delay line pair, wherein the first grounding guard trace is electrically connected to the grounding circuit through a plurality of first vias.

The second grounding guard trace is disposed in the layout layer in a manner of extending from the second opening toward the second coupling area, having an internal between the second grounding guard trace and the serpentine delay line pair, wherein the second grounding guard trace is electrically connected to the grounding circuit through a plurality of second vias.

The two third grounding guard traces are respectively disposed in the layout layer by an upper edge and a lower edge of the serpentine delay line pair, wherein the two third grounding guard traces are electrically connected to the grounding circuit through a plurality of third vias.

According to an embodiment of the present invention, a number of the first coupling area is the same as that of the second coupling area.

According to an embodiment of the present invention, the layout layer is disposed inside the substrate.

According to an embodiment of the present invention, the serpentine delay lines are selected from the group of a microstrip line and a strip line. Preferably, the serpentine delay lines include a microstrip line.

According to an embodiment of the present invention, the substrate is made from materials having a plurality of dielectric constants.

According to an embodiment of the present invention, two ends of the first grounding guard trace are connected to the first vias.

According to an embodiment of the present invention, two ends of the second grounding guard trace are connected to the second vias.

According to an embodiment of the present invention, two ends of the second grounding guard traces are connected to the third vias.

When compared with the differential serpentine delay line structure in the prior art, the present invention reduces the common-mode noise by means of the first grounding guard trace, the second grounding guard trace and the third grounding guard traces. Moreover, by narrowing the widths of the serpentine delay lines when the serpentine delay lines are bent, strong coupling line segments are generated and the common-mode noise is reduced. Therefore, the effect of reducing the common-mode noise of the present invention is better then that of the differential serpentine delay line structure in the prior art.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 shows a differential serpentine delay line structure in prior art;

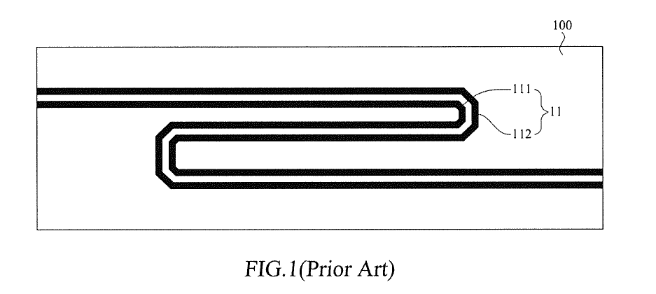

FIG. 2 is the upper view illustrating an embodiment of a differential serpentine delay line structure according to the present invention;

FIG. 3 shows a cross-sectional view illustrating an embodiment of a differential serpentine delay line structure according to the present invention;

FIG. 4 is a graph showing a comparison of return loss between an embodiment of a differential serpentine delay line structure and the prior art;

FIG. 5 is a graph showing a comparison of insertion loss between an embodiment of a differential serpentine delay line structure and the prior art;

FIG. 6 is a graph showing a comparison of differential-to-common conversion between an embodiment of a differential serpentine delay line structure of the present invention and the prior art; and

FIG. 7 is a graph showing a comparison of received signal waveform between an embodiment of a differential serpentine delay line structure of the present invention and the prior art.

### DETAILED DESCRIPTION OF THE PREFERRED EMBODIMENTS

The present invention relates to a delay line structure, and more particularly to a differential serpentine delay line structure with grounding guard traces and strong coupling line segments. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

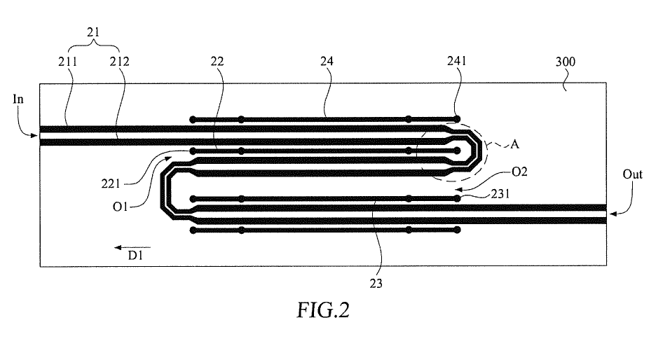

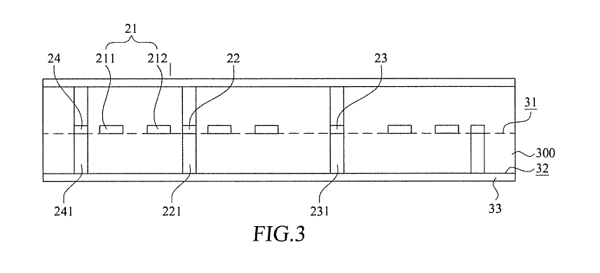

Referring to FIG. 2 and FIG. 3, wherein FIG. 2 is the upper view illustrating an embodiment of a differential serpentine delay line structure according to the present invention; FIG. 3 shows a cross-sectional view illustrating an embodiment of a differential serpentine delay line structure according to the present invention. A delay line structure is disposed on a substrate 300. The substrate 300 includes a grounding layer 31 and a layout layer 32, wherein the grounding layer 32 includes a grounding circuit 33. The delay line structure of the present invention accordingly includes a serpentine delay line pair 21 having two parallel serpentine delay lines 211 and 212, at least a first grounding guard trace 22, at least a second grounding guard trace 23, and two third grounding guard traces 24.

The serpentine delay line pair 21 is disposed in the layout layer 31 in a manner of extending from an input end “In” to an out put end “Out” in serpentine so as to form at least a first coupling area having a first opening O1 toward a first direction D1 and at least a second coupling area having a second opening O2 toward a direction opposite to the first direction D1, wherein the widths of the serpentine delay lines 211 and 212 are smaller when the serpentine delay lines are bent in a bending area A. The serpentine delay lines 211 and 212 in the bending area A are strong coupling line segments, which reduces the common-mode noise generated by unequal length of signal lines. According to an embodiment of the present invention, the number of first coupling area can be the same as or different from the number of the second coupling area. According to an embodiment of the present invention, the serpentine delay lines 211 and 212 are selected from the group of a microstrip line and a strip line. According to a preferable embodiment of the present invention, when the serpentine delay lines 211 and 212 include microstip lines, the effect of reducing the common-mode noise is more significant.

The first grounding guard trace 22 is disposed in the layout layer 31 in a manner of extending from the first opening O1 toward the first coupling area, has an interval between the first grounding guard trace 22 and the serpentine delay line pair 21, wherein the first grounding guard trace 22 is electrically connected to the grounding circuit 33 through a plurality of first vias 221. According to a preferable embodiment of the present invention, the two ends of the first grounding guard trace 22 are connected to the first vias 221.

The second grounding guard trace 23 is disposed in the layout layer 31 in a manner of extending from the second opening O2 toward the second coupling area, has an interval between the second grounding guard trace 23 and the serpentine delay line pair 21, wherein the second grounding guard trace 23 is electrically connected to the grounding circuit 33 through a plurality of second vias 231. According to a preferable embodiment of the present invention, the two ends of the second grounding guard trace 23 are connected to the second vias 231.

The two third grounding guard traces 24 are respectively disposed in the layout layer 31 by an upper edge and a lower edge of the serpentine delay line pair 21, wherein the two third grounding guard traces are electrically connected to the grounding circuit 33 through a plurality of third vias 241. According to a preferable embodiment of the present invention, the two ends of the third grounding guard traces 24 are connected to the third vias 241.

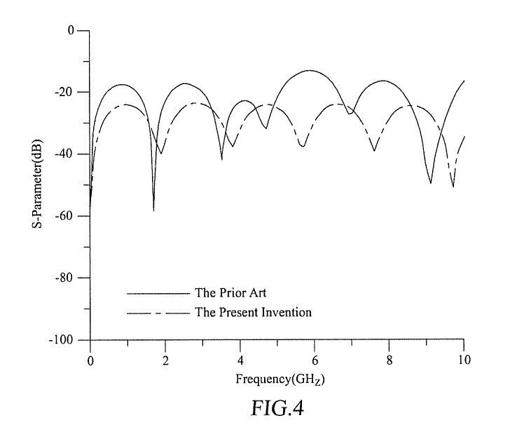

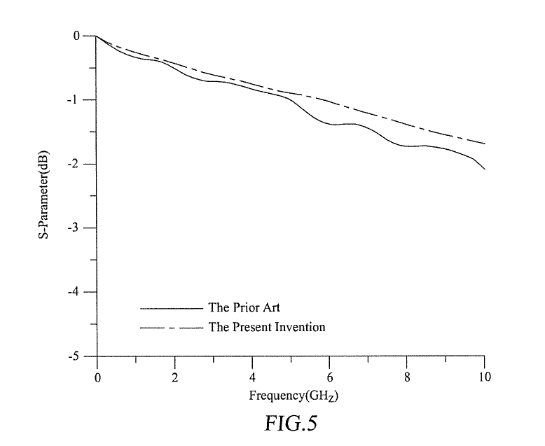

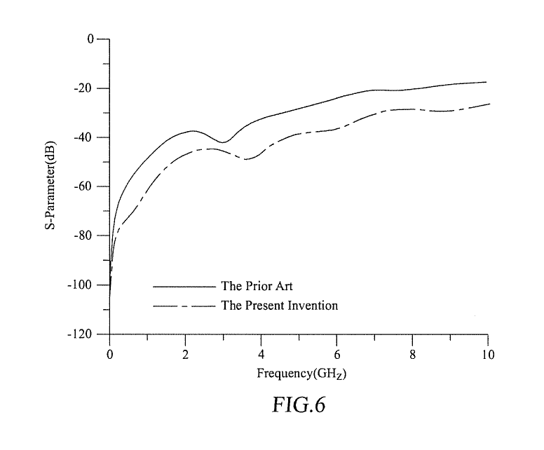

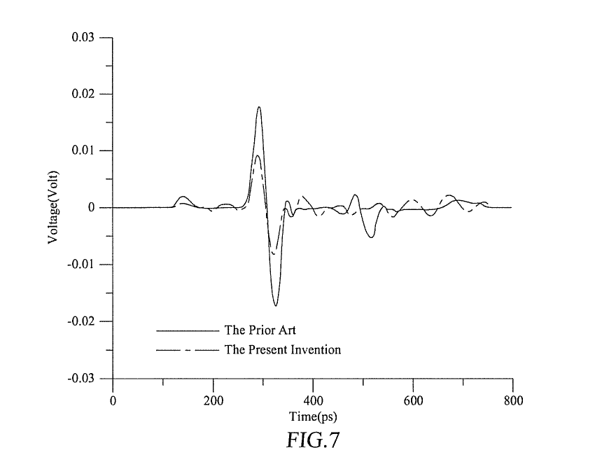

Referring to FIGS. 4, 5, 6 and 7, wherein FIG. 4 is a graph showing a comparison of return loss between an embodiment of a differential serpentine delay line structure of the present invention and the prior art; FIG. 5 is a graph showing a comparison of insertion loss between an embodiment of a differential serpentine delay line structure of the present invention and the prior art; FIG. 6 is a graph showing a comparison of differential-to-common conversion between an embodiment of a differential serpentine delay line structure and the prior art; while FIG. 7 is a graph showing a comparison of received signal waveform between an embodiment of a differential serpentine delay line structure and the prior art. It is obvious that when compared with the differential serpentine delay line structure in the prior art, the present invention reduces the common-mode noise more effectively so that the signal waveform is more ideal.

While the present invention has been particularly shown and described with reference to a preferred embodiment, it will be understood by those skilled in the art that various changes in form and detail may be without departing from the spirit and scope of the present invention.

What is claimed is:

1. A delay line structure disposed on a substrate, the substrate including a grounding layer and a layout layer, the grounding layer having a grounding circuit, the delay line structure comprising:
a serpentine delay line pair including two parallel serpentine delay lines, the serpentine delay line pair being disposed in the layout layer in a manner of extending from an input end to an out put end in serpentine so as to form at least a first coupling area having a first opening toward a first direction and at least a second coupling area having a second opening toward a second direction opposite to the first direction, wherein the widths of the serpentine delay lines are smaller when the serpentine delay lines are bent;
at least a first grounding guard trace disposed in the layout layer in a manner of extending from the first opening toward the first coupling area, having an interval between the first grounding guard trace and the serpentine delay line pair, wherein the first grounding guard trace is electrically connected to the grounding circuit through a plurality of first vias;
at least a second grounding guard trace disposed in the layout layer in a manner of extending from the second opening toward the second coupling area, having an internal between the second grounding guard trace and the serpentine delay line pair, wherein the second grounding guard trace is electrically connected to the grounding circuit through a plurality of second vias; and
two third grounding guard traces respectively disposed in the layout layer by an upper edge and a lower edge of the serpentine delay line pair, wherein the two third grounding guard traces are electrically connected to the grounding circuit through a plurality of third vias.

2. The delay line structure according to claim 1, wherein the number of the first coupling area is the same as that of the second coupling area.

3. The delay line structure according to claim 1, wherein the layout layer is disposed inside the substrate.

4. The delay line structure according to claim 1, wherein the serpentine delay lines are selected from the group of a microstrip line and a strip line.

5. The delay line structure according to claim 1, wherein the substrate is made from materials having a plurality of dielectric constants.

6. The delay line structure according to claim 1, wherein two ends of the first grounding guard trace are electrically connected to the first vias.

7. The delay line structure according to claim 1, wherein two ends of the second grounding guard trace are electrically connected to the second vias.
